(19) United States
(12) Patent Application Publication
(10) Pub. No.: US 2024/0076484 A1
(43) Pub. Date: Mar. 7, 2024

(54) TIRE INNERLINER COMPOSITIONS OF HALOGENATED BUTYL RUBBER, TERPENE PHENOL RESIN, CALCIUM CARBONATE FILLER, AND CURATIVE

(71) Applicant: Bridgestone Americas Tire Operations, LLC, Nashville, TN (US)

(72) Inventor: Justin J. Styer, Cortland, OH (US)

(73) Assignee: Bridgestone Americas Tire Operations, LLC, Nashville, TN (US)

(21) Appl. No.: 18/270,110

(22) PCT Filed: Dec. 12, 2021
(86) PCT No.: PCT/US21/73151

§ 371 Date: Jun. 28, 2023

Related U.S. Application Data
(60) Provisional application No. 63/131,772, filed on Dec. 29, 2020.

(51) Int. Cl. C08L 23/28; B60C 1/00; C08K 3/04; C08K 3/26

(52) U.S. Cl. CPC C08L 23/283; B60C 1/0008; C08K 3/04; C08K 3/26; C08K 2003/265; C08K 2201/006; C08L 2205/03; C08L 2205/06

(57) ABSTRACT

Embodiments of the present disclosure are directed to tire innerliner compositions comprising an elastomer component comprising halogenated butyl rubber; at least one terpene phenol resin; filler component comprising calcium carbonate; and at least one curative. The at least one terpene phenol resin has a softening point from 100° C. to 160° C. and a hydroxyl value from 40 to 200.

### TECHNICAL FIELD

Embodiments of the present disclosure are generally related to tire innerliner compositions, and are specifically related to tire innerliner compositions including a halogenated butyl rubber, a terpene phenol resin, calcium carbonate filler, and a curative having desirable gas permeability and sufficient durability and cure characteristics.

### BACKGROUND

Tire innerliners are intended to reduce gas permeability and inhibit oxygen travel through the tire. Butyl rubber compositions are commonly used to form tire innerliners because of their durability, blow point, and scorch. Butyl rubber is relatively gas permeable in its raw state. Accordingly, other materials, such as reinforcing and non-reinforcing fillers, including clays and/or other fillers having a layered morphology, are added to the butyl rubber composition in order to further reduce gas permeability. However, such fillers, alone or in combination with other fillers, may not provide the balance of reduced gas permeability with other compound properties, including durability and cure, as desired by those in the field.

Accordingly, a need exists for tire innerliner compositions that have improved gas permeability while providing the desired durability and cure when using butyl rubber compositions.

### SUMMARY

Embodiments of the present disclosure are directed to tire innerliner compositions comprising a blend of a halogenated butyl rubber, a terpene phenol resin, calcium carbonate filler, and a curative, which provide improved gas permeability while meeting the desired durability and cure.

According to one embodiment, a tire innerliner composition is provided. The tire innerliner composition comprises an elastomer component comprising halogenated butyl rubber; at least one terpene phenol resin; filler component comprising calcium carbonate; and at least one curative. The at least one terpene phenol resin has a softening point from 100° C. to 160° C. and a hydroxyl value from 40 to 200.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DETAILED DESCRIPTION

Reference will now be made in detail to various embodiments of tire innerliner compositions, specifically tire innerliner compositions comprising an elastomer component comprising halogenated butyl rubber; at least one terpene phenol resin having a softening point from 100° C. to 160° C. and a hydroxyl value from 40 to 200; filler component comprising calcium carbonate; and at least one curative.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The term “phr,” as described herein, refers to parts by weight of the identified component per 100 parts elastomer component.

The term “SBR,” as described herein, refers to styrene-butadiene copolymer rubber.

The term “functionalized,” as described herein, refers to the use of both functional groups and coupling agents.

The term “partial condensation product,” as described herein, refers to a product in which a part (not all) of a SiOR group in the hydrocarbyloxysilane compound is turned into a SiOSi bond by condensation.

The abbreviation “Mn,” as used herein, refers to number average molecular weight as measured using gel permeation chromatography (GPC) calibrated with styrene-butadiene standard and Mark-Houwink constants for the polymer in question.

The abbreviation “Mw,” as used herein, refers to weight average molecular weight as measured using gel permeation chromatography (GPC) calibrated with styrene-butadiene standard for SBC or with polystyrene standard for natural rubber and Mark-Houwink constants for the polymer in question.

The abbreviation “Mw/Mn,” as used herein refers to polydispersity (i.e., the degree of “non-uniformity” of a distribution).

The abbreviation “Tg,” as used herein, refers to a glass transition (Tg) measurement made upon the elastomer without any oil-extension. In other words, for an oil-extended elastomer, the Tg values refer to the Tg prior to oil extension or to a non-oil-extended version of the same elastomer. Elastomer or polymer Tg values are measured using a differential scanning calorimeter (DSC) instrument, such as manufactured by TA Instruments (New Castle, Delaware), where the measurement is conducted using a temperature elevation of 10° C./minute after cooling at −120° C. Thereafter, a tangent is drawn to the base lines before and after the jump of the DSC curve. The temperature on the DSC curve (read at the point corresponding to the middle of the two contact points) is used as Tg.

The term “vinyl bond content,” as described herein, refers to the overall vinyl bond content (i.e., 1,2-microstructure) in the SBR polymer chain rather than of the vinyl bond content in the butadiene portion of the SBR polymer chain, and is determined by H¹-NMR and C¹³-NMR (e.g., using a 300 MHz Gemini 300 NMR Spectrometer System (Varian)).

The terms “cis 1,4-bond content” or “cis bond content,” as described herein, refer to the cis 1,4-bond content as determined by FTIR (Fourier Transform Infrared Spectroscopy), wherein a polymer sample is dissolved in CS₂ and then subjected to FTIR.

The term “natural rubber,” as described herein, refers to naturally occurring rubber such as can be harvested from sources such as Hevea rubber trees and non-Hevea sources (e.g., guayule shrubs and dandelions such as TKS). In other words, the term “natural rubber” should be construed so as to exclude synthetic polyisoprene.

The term “hydroxyl value,” as described herein, is measured according to ASTM E222-17 using an instrument such as an 848 Titrino Plus from Metrohm.

The term “softening point,” as described herein, is measured according to ASTM E28-18 (a ring and ball method).

The term “nitrogen surface area,” as described herein, is measured according to ASTM D-1765 using the cetyltrimethyl-ammonium bromide (CTAB) technique.

The term “liquid plasticizer,” as described herein, refers to plasticizers that are liquid at 25° C., including, but not limited to oils and ester plasticizers.

The term “IP346 method,” as described herein, may be found in Standard Methods for Analysis & Testing of Petroleum and Related Products and British Standard 2000 Parts, 2003, 62nd edition, published by the Institute of Petroleum, United Kingdom.

As stated above, conventional butyl rubber compositions provide the durability, blow point, and scorch necessary for use as a tire innerliner. Other materials, such as reinforcing and non-reinforcing fillers, including clays and/or other fillers having a layered morphology, are added to the butyl rubber composition in order to further reduce gas permeability. However, such fillers, alone or in combination with other fillers, may not provide the balance of reduced gas permeability with other compound properties, including durability and cure, as desired by those in the field.

Disclosed herein are tire innerliner compositions, which mitigate the aforementioned problems. Specifically, the tire innerliner compositions disclosed herein comprise a blend of a halogenated butyl rubber, a terpene phenol resin, calcium carbonate filler, and a curative, which results in a rubber composition having desirable gas permeability and sufficient durability and cure characteristics.

The tire innerliner compositions disclosed herein may generally be described as comprising a blend of an elastomer component comprising halogenated butyl rubber, at least one terpene phenol resin, filler component comprising calcium carbonate filler, and at least one curative.

Elastomer Component

Halogenated Butyl Rubber

As described hereinabove, butyl rubber increases the durability and reduces the blow point and scorch of the tire innerliner composition. Accordingly, in one or more embodiments, the tire innerliner composition may comprise an elastomer component comprising a halogenated butyl rubber. Halobutyl rubber may include chlorobutyl rubber (CIIR), bromobutyl rubber (BIIR), or combinations thereof. In one or more embodiments, the halobutyl rubber may include from about 0.5 to about 5 percent by weight halogen atom, from about 0.7 to about 4 percent by weight halogen atom, or even from about 1 to about 3 percent by weight halogen atom, based upon the total weight of the halobutyl rubber.

In one or more embodiments, the halogenated bromobutyl rubber may be a brominated copolymer of isobutylene and isoprene (BIIR). The relative amounts of these monomers will determine the mole percent unsaturation of the resulting copolymer. In other words, the mole percent of isoprene in the copolymerization will correspond to the mole percent unsaturation in the copolymer. In one or more embodiments, the iso-butylene-based elastomer may have a mole percent unsaturation of less than about 3, less than about 2.5, or even less than about 2.

In one or more embodiments, the halogenated butyl rubber is included in an amount greater than or equal to 75 phr such that the halogenated butyl rubber may increase the durability of the tire innerliner composition. In one or more embodiments, the amount of halogenated butyl rubber may be limited (e.g., less than or equal to 100 phr) such that the gas permeability is not increased above a desired amount. In one or more embodiments, the amount of halogenated butyl rubber in the tire innerliner composition may be from 75 phr to 100 phr. In one or more embodiments, the amount of halogenated butyl rubber in the tire innerliner composition may be greater than or equal to 75 phr, greater than or equal to 80 phr, greater than or equal to 83 phr, greater than or equal to 85 phr, or even greater than or equal to 87 phr. In one or more embodiments, the amount of halogenated butyl rubber in the tire innerliner composition may be less than or equal to 100 phr, less than or equal to 97 phr, less than or equal to 95 phr, less than or equal to 93 phr, or even less than or equal to 90 phr. In one or more embodiments, the amount of amount of halogenated butyl rubber in the tire innerliner composition may be from 75 phr to 100 phr, from 75 phr to 97 phr, from 75 phr to 95 phr, from 75 phr to 93 phr, from 75 phr to 90 phr, from 80 phr to 100 phr, from 80 phr to 97 phr, from 80 phr to 95 phr, from 80 phr to 93 phr, from 80 phr to 90 phr, from 83 phr to 100 phr, from 83 phr to 97 phr, from 83 phr to 95 phr, from 83 phr to 93 phr, from 83 phr to 90 phr, from 85 phr to 100 phr, from 85 phr to 97 phr, from 85 phr to 95 phr, from 85 phr to 93 phr, from 85 phr to 90 phr, from 87 phr to 100 phr, from 87 phr to 97 phr, from 87 phr to 95 phr, from 87 phr to 93 phr, or even from 87 phr to 90 phr, or any and all sub-ranges formed from any of these endpoints.

Additional Rubber

In one or more embodiments, the elastomer component may further comprise an additional rubber, the additional rubber comprising styrene-butadiene copolymer rubber (SBR), polybutadiene rubber, natural rubber, polyisoprene rubber, or combinations thereof. For example, in one or more embodiments, the tire innerliner composition may further comprise natural rubber. In one or more embodiments, the amount of the additional rubber in the tire innerliner composition may be from 1 phr to 25 phr. In one or more embodiments, the amount of the additional rubber may be greater than or equal to 1 phr, greater than or equal to 3 phr, greater than or equal to 5 phr, or even greater than or equal to 7 phr. In one or more embodiments, the amount of the additional rubber in the tire innerliner composition may be less than or equal to 25 phr, less than or equal to 20 phr, less than or equal to 15 phr, or even less than or equal to 10 phr. In one or more embodiments, the amount of the additional rubber in the tire innerliner composition may be from 1 phr to 25 phr, from 1 phr to 20 phr, from 1 phr to 15 phr, from 1 phr to 10 phr, from 3 phr to 25 phr, from 3 phr to 20 phr, from 3 phr to 15 phr, from 3 phr to 10 phr, from 5 phr to 25 phr, from 5 phr to 20 phr, from 5 phr to 15 phr, from 5 phr to 10 phr, from 7 phr to 25 phr, from 7 phr to 20 phr, from 7 phr to 15 phr, or even from 7 phr to 10 phr, or any and all sub-ranges formed from any of these endpoints.

Styrene-Butadiene Copolymer Rubber

In one or more embodiments, the elastomer component of the tire innerliner composition may include styrene-butadiene copolymer rubber. In one or more embodiments, the styrene-butadiene copolymer rubber may be functionalized or non-functionalized. In one or more embodiments, one or more types of functional groups may be utilized for each SBR. Generally, a functional group may be present at the head of the polymer, at the tail of the polymer, along the backbone of the polymer chain, or a combination thereof. Functional groups present at one or both terminals of a polymer are generally the result of the use of a functional initiator, a functional terminator, or both. Alternatively or additionally, the functional group may be present as a result of coupling of multiple polymer chains using a coupling agent.

In one or more embodiments, the elastomer component may include at least one styrene-butadiene copolymer rubber that is functionalized. In one or more embodiments, the only styrene-butadiene copolymer rubber used in the elastomer component may be a styrene-butadiene copolymer rubber functionalized with a silica-reactive functional group. In other embodiments, the elastomer component may include at least one styrene-butadiene rubber which is not functionalized. In one or more embodiments, the non-functionalized styrene-butadiene rubber may be used in combination with a functionalized styrene-butadiene copolymer rubber (e.g., functionalized with a silica-reactive functional group). Non-limiting examples of silica-reactive functional groups generally include nitrogen-containing functional groups, silicon-containing functional groups, oxygen- or sulfur-containing functional groups, and metal-containing functional groups, as discussed in more detail below.

In one or more embodiments in which a functionalized SBR is used in the elastomer component, the functionalization may be achieved by adding a functional group to one or both terminus of the polymer, by adding a functional group to the backbone of the polymer (or a combination of the foregoing) or by coupling more than one polymer chains to a coupling agent, or by a combination thereof. In one or more embodiments, such effects may be achieved by treating a living polymer with coupling agents, functionalizing agents, or a combination thereof which serve to couple and/or functionalize other chains. In one or more embodiments, the functionalized SBR may contain one or more functional groups but may not be coupled (i.e., does not contain any coupling agents). Generally, a coupling agent and/or functionalizing agent can be used at various molar ratios. Alternatively, in other embodiments, the functionalized SBR may be silica-reactive merely from the result of using a coupling agent. Although reference is made herein to the use of both coupling agents and functionalizing groups (and compounds used therefor), those skilled in the art may appreciate that certain compounds may serve both functions. That is, certain compounds may both couple and provide the polymer chains with a functional group. Those skilled in the art may also appreciate that the ability to couple polymer chains may depend upon the amount of coupling agent reacted with the polymer chains. For example, advantageous coupling may be achieved where the coupling agent is added in a one to one ratio between the equivalents of lithium on the initiator and equivalents of leaving groups (e.g., halogen atoms) on the coupling agent. Non-limiting examples of coupling agents include metal halides, metalloid halides, alkoxysilanes, alkoxystannanes, and combinations thereof.

Non-limiting examples of nitrogen-containing functional groups that may be utilized in embodiments as a silica-reactive functional group in the SBR include, but are not limited to, a substituted or unsubstituted amino group, an amide residue, an isocyanate group, an imidazolyl group, an indolyl group, an imino group, a nitrile group, a pyridyl group, and a ketimine group. The foregoing substituted or unsubstituted amino group should be understood to include a primary alkylamine, a secondary alkylamine, or a cyclic amine, and an amino group derived from a substituted or unsubstituted imine. In one or more embodiments, the SBR of the elastomer component may comprise at least one silica-reactive functional group selected from the foregoing list of nitrogen-containing functional groups.

In one or more embodiments, the SBR may include a silica-reactive functional group from a compound which includes nitrogen in the form of an imino group. Such an imino-containing functional group may be added by reacting the active terminal of a polymer chain with a compound having the following formula (I):

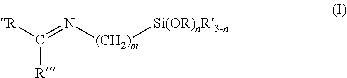

wherein R, R′, R″, and R′″ each independently are selected from a group having from 1 to 18 carbon atoms selected from the group consisting of an alkyl group, an allyl group, and an aryl group; m and n are integers from 1 to 20 and from 1 to 3, respectively. In one or more embodiments, each of R, R′, R″, and R′″ may be hydrocarbyl and contain no heteroatoms. In one or more embodiments, each R and R′ may be independently selected from an alkyl group having from 1 to 6 carbon atoms or even from 1 to 3 carbon atoms. In one or more embodiments, m may be an integer from 2 to 6 or even from 2 to 3. In one or more embodiments, R′″ may be selected from a group having from 1 to 6 carbon atoms or even from 2 to 4 carbon atoms. In one or more embodiments, R″ may be selected from an alkyl group having from 1 to 6 carbon atoms, from 1 to 3 carbon atoms, or even 1 carbon atom (e.g., methyl). In one or more embodiments, n may be 3, resulting in a compound with a trihydrocarboxysilane moiety such as a trialkoxysilane moiety. Non-limiting examples of compounds having an imino group and meeting formula (I) above, which are suitable for providing the silica-reactive functional group for the SBR include, but are not limited to, N-(1,3-dimethylbutylidene)-3-(triethoxysilyl)-1-propaneamine, N-(1-methyl ethylidene)-3-(triethoxy silyl)-1-propaneamine, N-ethylidene-3-(triethoxysilyl)-1-propaneamine, N-(1-methylpropylidene)-3-(triethoxysilyl)-1-propaneamine, and N-(4-N,N-dimethylaminobenzylidene)-3-(triethoxysilyl)-1-propaneamine.

Non-limiting examples of silicon-containing functional groups that may be utilized in embodiments as a silica-reactive functional group in the SBR include, but are not limited to, an organic silyl or siloxy group. For example, in one or more embodiments, a functional group may be selected from an alkoxysilyl group, an alkylhalosilyl group, a siloxy group, an alkylaminosilyl group, and an alkoxyhalosilyl group. In one or more embodiments, the organic silyl or siloxy group may also contain one or more nitrogens. Suitable silicon-containing functional groups for use in functionalizing diene-based elastomers may also include those disclosed in U.S. Pat. No. 6,369,167, the entire disclosure of which is herein incorporated by reference. In one or more embodiments, the SBR may comprise at least one silica-reactive functional group selected from the foregoing list of silicon-containing functional groups.

In other embodiments, the SBR may include a silica-reactive functional group which includes a silicon-containing functional group having a siloxy group (e.g., a hydrocarbyloxysilane-containing compound), wherein the compound optionally includes a monovalent group having at least one functional group. Such a silicon-containing functional group may be added by reacting the active terminal of a polymer chain with a compound having the following formula (II):

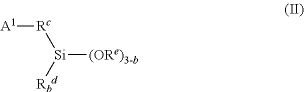

wherein A¹ represents a monovalent group having at least one functional group selected from epoxy, isocyanate, imine, cyano, carboxylic ester, carboxylic anhydride, cyclic tertiary amine, non-cyclic tertiary amine, pyridine, silazane and sulfide; R^{c} represents a single bond or a divalent hydrocarbon group having from 1 to 20 carbon atoms; R^{d} represents a monovalent aliphatic hydrocarbon group having from 1 to 20 carbon atoms, a monovalent aromatic hydrocarbon group having from 6 to 18 carbon atoms or a reactive group; R^{e} represents a monovalent aliphatic hydrocarbon group having from 1 to 20 carbon atoms or a monovalent aromatic hydrocarbon group having from 6 to 18 carbon atoms; b is an integer from 0 to 2; when more than one R^{d} or OR^{e} are present, each R^{d} and/or OR^{e} may be the same as or different from each other; and an active proton is not contained in a molecule) and/or a partial condensation product thereof. In one or more embodiments, at least one of the following is met: (a) R^{c} represents a divalent hydrocarbon group having from 1 to 12 carbon atoms, from 2 to 6 carbon atoms, or even from 2 to 3 carbon atoms; (b) R^{e} represents a monovalent aliphatic hydrocarbon group having from 1 to 12 carbon atoms, from 2 to 6 carbon atoms, or even from 1 to 2 carbon atoms or a monovalent aromatic hydrocarbon group having from 6 to 8 carbon atoms; (c) R^{d} represents a monovalent aliphatic hydrocarbon group having from 1 to 12 carbon atoms, from 2 to 6 carbon atoms, or even from 1 to 2 carbon atoms or a monovalent aromatic hydrocarbon group having from 6 to 8 carbon atoms; in certain such embodiments, each of (a), (b) and (c) are met and R^{c}, R^{e}, and R^{d} are selected from one of the foregoing groups.

In one or more embodiments, the functional group of the SBR may result from a compound represented by Formula (II) wherein A¹ has at least one epoxy group. Non-limiting specific examples of such compounds include 2-glycidoxyethyltrimethoxysilane, 2-glycidoxyethyltriethoxysilane, (2-glycidoxyethyl)methyl dimethoxy silane, 3-glycidoxypropyltrimethoxysilane, 3-glycidoxypropyltriethoxysilane, (3-glycidoxypropyl)-methyldimethoxysilane, 2-(3,4-epoxycyclohexyl)ethyltrimethoxysilane, 2-(3,4-epoxycyclohexyl)ethyltriethoxysilane, 2-(3,4-epoxycyclohexyl)ethyl(methyl)dimethoxysilane, and the like.

In other embodiments, the functional group of the SBR may result from a compound represented by Formula (II) wherein A¹ has at least one isocyanate group. Non-limiting specific examples of such compounds include 3-isocyanatopropyltrimethoxysilane, 3-isocyanatopropyltriethoxysilane, 3-isocyanatopropylmethyldiethoxysilane, 3-isocyanatopropyltriisopropoxysilane, and the like.

In other embodiments, the functional group of the SBR may result from a compound represented by Formula (II) wherein A¹ has at least one imine group. Non-limiting specific examples of such compounds include N-(1,3-dimethylbutylidene)-3-(triethoxysilyl)-1-propaneamine, N-(1-methylethylidene)-3-(triethoxysilyl)-1-propaneamine, N-ethylidene-3-(triethoxysilyl)-1-propaneamine, N-(1-methylpropylidene)-3-(triethoxysilyl)-1-propaneamine, N-(4-N,N-dimethylaminobenzylidene)-3-(triethoxysilyl)-1-propaneamine, N-(cyclohexylidene)-3-(triethoxysilyl)-1-propaneamine and trimethoxysilyl compounds, methyldiethoxysilyl compounds, ethyldimethoxysilyl compounds, and the like each corresponding to the above triethoxysilyl compounds. In one or more embodiments, the imine(amidine) group-containing compounds may include 1-[3-trimethoxysilyl]propyl]-4,5-dihydroimidazole, 3-(1-hexamethyleneimino)propyl(triethoxy)silane, (1-hexamethyleneimino)methyl(trimethoxy)silane, N-(3-triethoxysilylpropyl)-4,5-dihydroimidazole, N-(3-isopropoxysilylpropyl)-4,5-dihydroimidazole, N-(3-methyldiethoxysilylpropyl)-4,5-dihydroimidazole, and the like.

In other embodiments, the functional group of the SBR may result from a compound represented by Formula (II) wherein A¹ has at least one carboxylic ester group. Non-limiting specific examples of such compounds include 3-methacryloyloxypropyltriethoxysilane, 3-methacryloyloxypropyltrimethoxysilane, 3-methacryloyloxypropylmethyldiethoxysilane, 3-methacryloyloxypropyltriisopropoxysilane, and the like.

In other embodiments, the functional group of the SBR may result from a compound represented by Formula (II) wherein A¹ has at least one carboxylic anhydride group. Non-limiting specific examples of such compounds include 3-trimethoxysilylpropylsuccinic anhydride, 3-triethoxysilylpropyl succinic anhydride, 3-methyldiethoxysilylpropylsuccinic anhydride, and the like.

In other embodiments, the functional group of the SBR may result from a compound represented by Formula (II) wherein A¹ has at least one cyano group. Non-limiting specific examples of such compounds include 2-cyanoethylpropyltriethoxysilane and the like.

In other embodiments, the functional group of the SBR may result from a compound represented by Formula (II) wherein A¹ has at least one cyclic tertiary amine group. Non-limiting specific examples of such compounds include 3-(1-hexamethyleneimino)propyltriethoxysilane, 3-(1-hexamethyleneimino)propyltrimethoxysilane, (1-hexamethyleneimino)methyltriethoxysilane, (1-hexamethyleneimino)methyltrimethoxysilane, 2-(1-hexamethyleneimino)ethyltriethoxysilane, 3-(1-hexamethyleneimino)ethyltrimethoxysilane, 3-(1-pyrrolidinyl)propyltrimethoxysilane, 3-(1-pyrrolidinyl)propyltriethoxysilane, 3-(1-heptamethyleneimino)propyltriethoxysilane, 3-(1-dodecamethyleneimino)propyltriethoxysilane, 3-(1-hexamethyleneimino)propyldi ethoxymethyl silane, 3-(1-hexamethyleneimino)propyldiethoxyethylsilane, 3-[10-(triethoxysilyl)decyl]-4-oxazoline and the like.

In other embodiments, the functional group of the SBR may result from a compound represented by Formula (II) wherein A¹ has at least one non-cyclic tertiary amine group. Non-limiting specific examples of such compounds include 3-dimethylaminopropyltriethoxysilane, 3-dimethylaminopropyltrimethoxysilane, 3-diethylaminopropyltriethoxysilane, 3-dimethylaminopropyltrimethoxysilane, 2-dimethylaminoethyltriethoxysilane, 2-dimethylaminoethyltrimethoxysilane, 3-dimethylaminopropyldiethoxymethylsilane, 3-dibutylaminopropyltriethoxysilane, and the like.

In other embodiments, the functional group of the SBR may result from a compound represented by Formula (II) wherein A¹ has at least one pyridine group. Non-limiting specific examples of such compounds include 2-trimethoxysilylethylpyridine, and the like.

In other embodiments, the functional group of the SBR may result from a compound represented by Formula (II) wherein A¹ has at least one silazane group. Non-limiting specific examples of such compounds include N,N-bis(trimethyl silyl)-aminopropylmethyldimethoxysilane, 1-trimethyl silyl-2,2-dimethoxy-1-aza-2-silacyclopentane, N,N-bis(trimethyl silyl)aminopropyltrimethoxysilane, N,N-bis(trimethyl silyl)aminopropyltriethoxysilane, N,N-bis(trimethyl silyl)aminopropylmethyldiethoxysilane, N,N-bis(trimethyl silyl)aminoethyltrimethoxysilane, N,N-bis(trimethyl silyl)aminoethyltriethoxysilane, N,N-bis(trimethylsilyl)aminoethylmethyldimethoxysilane, N,N-bis(trimethylsilyl)aminoethylmethyldiethoxysilane, and the like.

In one or more embodiments wherein a silica-reactive functional group according to Formula (II) is used wherein A¹ contains one or more protected nitrogens (as discussed in detail above), the nitrogen(s) may be deprotected or deblocked by hydrolysis or other procedures to convert the protected nitrogen(s) into a primary nitrogen. As a non-limiting example, a nitrogen bonded to two trimethylsilyl groups could be deprotected and converted to a primary amine nitrogen (such a nitrogen would still be bonded to the remainder of the formula (II) compound). Accordingly, in embodiments wherein a silica-reactive functional group of the SBR results from use of a compound according to Formula (II) wherein A¹ contains one or more protected nitrogens, the functionalized polymer may be understood as containing a functional group resulting from a deprotected (or hydrolyzed) version of the compound.

Non-limiting examples of oxygen- or sulfur-containing functional groups that may be utilized in embodiments as a silica-reactive functional group in the SBR include, but are not limited to, a hydroxyl group, a carboxyl group, an epoxy group, a glycidoxy group, a diglycidylamino group, a cyclic dithiane-derived functional group, an ester group, an aldehyde group, an alkoxy group, a ketone group, a thiocarboxyl group, a thioepoxy group, a thioglycidoxy group, a thiodiglycidylamino group, a thioester group, a thioaldehyde group, a thioalkoxy group, and a thioketone group. In one or more embodiments, the foregoing alkoxy group may be an alcohol-derived alkoxy group derived from a benzophenone. In other embodiments, the SBR may comprise at least silica-reactive functional group selected from the foregoing list of oxygen- or sulfur-containing functional groups.

In one or more embodiments, the SBRs having a silica-reactive functional group may be prepared by either solution polymerization or by emulsion polymerization. In one or more embodiments, the only SBR or SBR having a silica-reactive functional group may be prepared by solution polymerization. In other embodiments, the only SBR or SBR having a silica-reactive functional group may be prepared by emulsion polymerization. In embodiments, when more than one SBR or SBR having a silica-reactive functional group is used, the rubbers may be a combination of solution polymerized SBR and emulsion polymerized SBR (e.g., one solution SBR and one emulsion SBR). In other embodiments, the only SBR(s) present in the elastomer component (including for the SBR having a silica-reactive functional group) may be a solution SBR (i.e., no emulsion SBR is present).

In one or more embodiments, the coupling agent for the SBR comprises a metal halide or metalloid halide selected from the group comprising compounds expressed by the formula (1) R*ₙM¹Y₍₄₋ₙ₎, the formula (2) M¹Y₄, and the formula (3) M²Y₃, where each R* is independently a monovalent organic group having 1 to 20 carbon atoms, M¹ is a tin atom, silicon atom, or germanium atom, M² is a phosphorous atom, Y is a halogen atom, and n is an integer of 0-3.

Exemplary compounds expressed by the formula (1) include halogenated organic metal compounds, and the compounds expressed by the formulas (2) and (3) include halogenated metal compounds.

In one or more embodiments where M¹ represents a tin atom, the compounds expressed by the formula (1) may be, for example, triphenyltin chloride, tributyltin chloride, triisopropyltin chloride, trihexyltin chloride, trioctyltin chloride, diphenyltin dichloride, dibutyltin dichloride, dihexyltin dichloride, dioctyltin dichloride, phenyltin trichloride, butyltin trichloride, octyltin trichloride, and the like. Furthermore, tin tetrachloride, tin tetrabromide, and the like may be exemplified as the compounds expressed by formula (2).

In other embodiments where M¹ represents a silicon atom, the compounds expressed by the formula (1) may be, for example, triphenylchlorosilane, trihexylchlorosilane, trioctylchlorosilane, tributylchlorosilane, trimethylchlorosilane, diphenyldichlorosilane, dihexyldichlorosilane, dioctyldichlorosilane, dibutyldichlorosilane, dimethyldichlorosilane, methyltrichlorosilane, phenyltrichlorosilane, hexyltrichlorosilane, octyltrichlorosilane, butyltrichlorosilane, methyltrichlorosilane, and the like. Furthermore, silicon tetrachloride, silicon tetrabromide and the like may be exemplified as the compounds expressed by the formula (2).

In other embodiments where M¹ represents a germanium atom, the compounds expressed by the formula (1) may be, for example, triphenylgermanium chloride, dibutylgermanium dichloride, diphenylgermanium dichloride, butylgermanium trichloride and the like. Furthermore, germanium tetrachloride, germanium tetrabromide, and the like can be exemplified as the compounds expressed by the formula (2). Phosphorous trichloride, phosphorous tribromide and, the like may be exemplified as the compounds expressed by the formula (3). In embodiments, mixtures of metal halides and/or metalloid halides may be used.

In one or more embodiments, the coupling agent for the SBR may comprise an alkoxysilane or alkoxystannane selected from the group comprising compounds expressed by the formula (4) R*ₙM¹ (OR\hat{ })₄₋ₙ, where each R*is independently a monovalent organic group having from 1 to 20 carbon atoms, M¹ is a tin atom, silicon atom, or germanium atom, OR\hat{ } is an alkoxy group where RA is a monovalent organic group, and n is an integer from 0 to 3.

Exemplary compounds expressed by the formula (4) include tetraethyl orthosilicate, tetramethyl orthosilicate, tetrapropyl orthosilicate, tetraethoxy tin, tetramethoxy tin, and tetrapropoxy tin.

In one or more embodiments, the SBR may have a Mw greater than or equal to 300,000 g/mol; greater than or equal to 325,000 g/mol; greater than or equal to 350,000 g/mol; greater than or equal to 375,000 g/mol; greater than or equal to 400,000 g/mol; or even greater than or equal to 425,000 g/mol. In one or more embodiments, the SBR may have a Mw less than or equal to 600,000 g/mol; less than or equal to 575,000 g/mol; less than or equal to 550,000 g/mol; less than or equal to 525,000 g/mol; less than or equal to 500,000 g/mol; less than or equal to 475,000 g/mol; or even less than or equal to 450,000 g/mol. In one or more embodiments, the SBR may have a Mw from 300,000 g/mol to 600,000 g/mol; from 300,000 g/mol to 575,000 g/mol; from 300,000 g/mol to 550,000 g/mol; from 300,000 g/mol to 525,000 g/mol; from 300,000 g/mol to 500,000 g/mol; from 300,000 g/mol to 475,000 g/mol; from 300,000 g/mol to 450,000 g/mol; from 325,000 g/mol to 600,000 g/mol; from 325,000 g/mol to 575,000 g/mol; from 325,000 g/mol to 550,000 g/mol; from 325,000 g/mol to 525,000 g/mol; from 325,000 g/mol to 500,000 g/mol; from 325,000 g/mol to 475,000 g/mol; from 325,000 g/mol to 450,000 g/mol; from 350,000 g/mol to 600,000 g/mol; from 350,000 g/mol to 575,000 g/mol; from 350,000 g/mol to 550,000 g/mol; from 350,000 g/mol to 525,000 g/mol; from 350,000 g/mol to 500,000 g/mol; from 350,000 g/mol to 475,000 g/mol; from 350,000 g/mol to 450,000 g/mol; from 375,000 g/mol to 600,000 g/mol; from 375,000 g/mol to 575,000 g/mol; from 375,000 g/mol to 550,000 g/mol; from 375,000 g/mol to 525,000 g/mol; from 375,000 g/mol to 500,000 g/mol; from 375,000 g/mol to 475,000 g/mol; from 375,000 g/mol to 450,000 g/mol; from 400,000 g/mol to 600,000 g/mol; from 400,000 g/mol to 575,000 g/mol; from 400,000 g/mol to 550,000 g/mol; from 400,000 g/mol to 525,000 g/mol; from 400,000 g/mol to 500,000 g/mol; from 400,000 g/mol to 475,000 g/mol; from 400,000 g/mol to 450,000 g/mol; from 425,000 g/mol to 600,000 g/mol; from 425,000 g/mol to 575,000 g/mol; from 425,000 g/mol to 550,000 g/mol; from 425,000 g/mol to 525,000 g/mol; from 425,000 g/mol to 500,000 g/mol; from 425,000 g/mol to 475,000 g/mol; or even from 425,000 g/mol to 450,000 g/mol; or any and all sub-ranges formed from any of these endpoints.

In one or more embodiments, the SBR may have a Mn greater than or equal to 200,000 g/mol; greater than or equal to 225,000 g/mol; greater than or equal to 250,000 g/mol; or even greater than or equal to 275,000 g/mol. In one or more embodiments, the SBR may have a Mn less than or equal to 400,000 g/mol; less than or equal to 375,000 g/mol; less than or equal to 350,000 g/mol; less than or equal to 325,000 g/mol; or even less than or equal to 300,000 g/mol. In one or more embodiments, the SBR may have a Mn from 200,000 g/mol to 400,000 g/mol; from 200,000 g/mol to 375,000 g/mol; from 200,000 g/mol to 350,000 g/mol; from 200,000 g/mol to 325,000 g/mol; from 200,000 g/mol to 300,000 g/mol; from 225,000 g/mol to 400,000 g/mol; from 225,000 g/mol to 375,000 g/mol; from 225,000 g/mol to 350,000 g/mol; from 225,000 g/mol to 325,000 g/mol; from 225,000 g/mol to 300,000 g/mol; from 250,000 g/mol to 400,000 g/mol; from 250,000 g/mol to 375,000 g/mol; from 250,000 g/mol to 350,000 g/mol; from 250,000 g/mol to 325,000 g/mol; from 250,000 g/mol to 300,000 g/mol; from 275,000 g/mol to 400,000 g/mol; from 275,000 g/mol to 375,000 g/mol; from 275,000 g/mol to 350,000 g/mol; from 275,000 g/mol to 325,000 g/mol; or even from 275,000 g/mol to 300,000 g/mol; or any and all sub-ranges formed from any of these endpoints.

In one or more embodiments, the SBR may have a Mw/Mn (polydispersity) greater than or equal to 1.2, greater than or equal to 1.3, greater than or equal to 1.4, greater than or equal to 1.5, or even greater than or equal to 1.6. In one or more embodiments, the SBR may have a Mw/Mn less than or equal to 2.5, less than or equal to 2.4, less than or equal to 2.3, less than or equal to 2.2, less than or equal to 2.1, or even less than or equal to 2. In one or more embodiments, the SBR may have a Mw/Mn from 1.2 to 2.5, from 1.2 to 2.4, from 1.2 to 2.3, from 1.2 to 2.2, from 1.2 to 2.1, from 1.2 to 2, from 1.3 to 2.5, from 1.3 to 2.4, from 1.3 to 2.3, from 1.3 to 2.2, from 1.3 to 2.1, from 1.3 to 2, from 1.4 to 2.5, from 1.4 to 2.4, from 1.4 to 2.3, from 1.4 to 2.2, from 1.4 to 2.1, from 1.4 to 2, from 1.5 to 2.5, from 1.5 to 2.4, from 1.5 to 2.3, from 1.5 to 2.2, from 1.5 to 2.1, from 1.5 to 2, from 1.6 to 2.5, from 1.6 to 2.4, from 1.6 to 2.3, from 1.6 to 2.2, from 1.6 to 2.1, or even from 1.6 to 2, or any and all sub-ranges formed from any of these endpoints.

In one or more embodiments, the SBR may have a Tg greater than or equal to −75° C., greater than or equal to −65° C., or even greater than or equal to −55° C. In one or more embodiments, the SBR may have a Tg less than or equal to −10° C., less than or equal to −20° C., less than or equal to −30° C., or even less than or equal to −40° C. In one or more embodiments, the SBR may have a Tg from −75° C. to −10° C., from −75° C. to −20° C., from −75° C. to −30° C., from −75° C. to −40° C., from −65° C. to −10° C., from −65° C. to −20° C., from −65° C. to −30° C., from −65° C. to −40° C., from −55° C. to −10° C., from −55° C. to −20° C., from −55° C. to −30° C., or even from −55° C. to −40° C., or any and all sub-ranges formed from any of these endpoints.

In one or more embodiments, the SBR may have a styrene monomer content greater than or equal to 10 wt % or even greater than or equal to 15 wt %. In one or more embodiments, the SBR may have a styrene monomer content less than or equal to 40 wt %, less than or equal to 30 wt %, less than or equal to 25 wt %, or even less than or equal to 20 wt %. In one or more embodiments, the SBR may have a styrene monomer content from 10 wt % to 40 wt %, from 10 wt % to 30 wt %, from 10 wt % to 25 wt %, from 10 wt % to 20 wt %, from 15 wt % to 40 wt %, from 15 wt % to 30 wt %, from 15 wt % to 25 wt %, or even from 15 wt % to 20 wt %, or any and all sub-ranges formed from any of these endpoints.

In one or more embodiments, the SBR may have a vinyl bond content greater than or equal to 10%, greater than or equal to 15%, greater than or equal to 20%, or even greater than or equal to 25%. In one or more embodiments, the SBR may have a vinyl bond content less than or equal to 50%, less than or equal to 45%, less than or equal to 40%, or even less than or equal to 35%. In one or more embodiments, the SBR may have a vinyl bond content from 10% to 50%, from 10% to 45%, from 10% to 40%, from 10% to 35%, from 15% to 50%, from 15% to 45%, from 15% to 40%, from 15% to 35%, from 20% to 50%, from 20% to 45%, from 20% to 40%, from 20% to 35%, from 25% to 50%, from 25% to 45%, from 25% to 40%, or even from 25% to 35%, or any and all sub-ranges formed from any of these endpoints.

Polybutadiene

In one or more embodiments, the elastomer component of the tire innerliner composition may include polybutadiene rubber.

In one or more embodiments, the polybutadiene rubber may have a cis bond content greater than or equal to 95%, greater than or equal to 96%, greater than or equal to 97%, greater than or equal to 98%, or even greater than or equal to 99%.

In one or more embodiments, the polybutadiene rubber may have a Tg greater than or equal to −110° C. or even greater than or equal to −108° C. In one or more embodiments, the polybutadiene rubber may have a Tg less than or equal to −101° C. or even less than or equal to −105° C. In one or more embodiments, the polybutadiene rubber may have a Tg from −110° C. to −101° C., from −108° C. to −101° C., from −110° C. to −105° C., or even from −108° C. to −105° C., or any and all sub-ranges formed from any of these endpoints.

In other embodiments, the polybutadiene rubber having a cis bond content greater than or equal to 95% and a Tg less than or equal to −101° C. may be used in the elastomer component.

In one or more embodiments, a polybutadiene may contain less than or equal to 3 wt %, less than or equal to 2 wt %, less than or equal to 1 wt %, less than or equal to 0.5 wt %, or even 0 wt % syndiotactic 1,2-polybutadiene.

Natural Rubber

In one or more embodiments, the elastomer component of the tire innerliner composition may include natural rubber. In one or more embodiments, the natural rubber may comprise Hevea natural rubber, non-Hevea natural rubber (e.g., guayule natural rubber), or a combination thereof.

In one or more embodiments, the natural rubber may have a Mw greater than or equal to 1 million g/mol, greater than or equal to 1.1 million g/mol, greater than or equal to 1.2 million g/mol, greater than or equal to 1.3 million g/mol, greater than or equal to 1.4 million g/mol, or even greater than or equal to 1.5 million g/mol. In one or more embodiments, the natural rubber may have a Mw less than or equal to 2 million g/mol, less than or equal to 1.9 million g/mol, less than or equal to 1.8 million g/mol, less than or equal to 1.7 million g/mol, or even less than or equal to 1.6 million g/mol. In one or more embodiments, the natural rubber may have a Mw from 1 million g/mol to 2 million g/mol, from 1 million g/mol to 1.9 million g/mol, from 1 million g/mol to 1.8 million g/mol, from 1 million g/mol to 1.7 million g/mol, from 1 million g/mol to 1.6 million g/mol, from 1.1 million g/mol to 2 million g/mol, from 1.1 million g/mol to 1.9 million g/mol, from 1.1 million g/mol to 1.8 million g/mol, from 1.1 million g/mol to 1.7 million g/mol, from 1.1 million g/mol to 1.6 million g/mol, from 1.2 million g/mol to 2 million g/mol, from 1.2 million g/mol to 1.9 million g/mol, from 1.2 million g/mol to 1.8 million g/mol, from 1.2 million g/mol to 1.7 million g/mol, from 1.2 million g/mol to 1.6 million g/mol, from 1.3 million g/mol to 2 million g/mol, from 1.3 million g/mol to 1.9 million g/mol, from 1.3 million g/mol to 1.8 million g/mol, from 1.3 million g/mol to 1.7 million g/mol, from 1.3 million g/mol to 1.6 million g/mol, from 1.4 million g/mol to 2 million g/mol, from 1.4 million g/mol to 1.9 million g/mol, from 1.4 million g/mol to 1.8 million g/mol, from 1.4 million g/mol to 1.7 million g/mol, from 1.4 million g/mol to 1.6 million g/mol, from 1.5 million g/mol to 2 million g/mol, from 1.5 million g/mol to 1.9 million g/mol, from 1.5 million g/mol to 1.8 million g/mol, from 1.5 million g/mol to 1.7 million g/mol, or even from 1.5 million g/mol to 1.6 million g/mol, or any and all sub-ranges formed from any of these endpoints.

In one or more embodiments, the natural rubber may have a Tg greater than or equal to −80° C., greater than or equal to −77° C., or even greater than or equal to −75° C. In one or more embodiments, the natural rubber may have a Tg less than or equal to −65° C., less than or equal to −67° C., or even less than or equal to −70° C. In one or more embodiments, the natural rubber may have a Tg from −80° C. to −65° C., from −80° C. to −67° C., from −80° C. to −70° C., from −77° C. to −65° C., from −77° C. to −67° C., from −77° C. to −70° C., from −75° C. to −65° C., from −75° C. to −67° C., or even from −75° C. to −70° C., or any and all sub-ranges formed from any of these endpoints.

Polyisoprene

In one or more embodiments, the elastomer component of the tire innerliner composition may include polyisoprene. In one or more embodiments, the polyisoprene may have a Tg greater than or equal to −55° C., greater than or equal to −58° C., or even greater than or equal to −60° C. In one or more embodiments, the polyisoprene may have a Tg less than or equal to −75° C., less than or equal to −73° C., less than or equal to −70° C., less than or equal to −67° C., or even less than or equal to −65° C. In one or more embodiments, the polyisoprene may have a Tg from −55° C. to −75° C., from −55° C. to −73° C., from −55° C. to −70° C., from −55° C. to −67° C., from −55° C. to −65° C., from −58° C. to −75° C., from −58° C. to −73° C., from −58° C. to −70° C., from −58° C. to −67° C., from −58° C. to −65° C., from −60° C. to −75° C., from −60° C. to −73° C., from −60° C. to −70° C., from −60° C. to −67° C., or even from −60° C. to −65° C., or any and all sub-ranges formed from any of these endpoints.

Terpene Phenol Resin

As described hereinabove, the inclusion of terpene phenol resin results in a tire innerliner composition having reduced gas permeability. Accordingly, in one or more embodiments, the tire innerliner composition may comprise at least one terpene phenol resin.

In one or more embodiments, the at least one terpene phenol resin is included in an amount greater than or equal to 1 phr such that the terpene phenol resin may reduce the gas durability of the tire innerliner composition. In one or more embodiments, the amount of the at least one terpene phenol resin in the tire innerliner composition may be greater than or equal to 1 phr, greater than or equal to 2 phr, greater than or equal to 3 phr, greater than or equal to 4 phr, or even greater than or equal to 5 phr. In one or more embodiments, the amount of the at least one terpene phenol resin in the tire innerliner composition may be less than or equal to 15 phr, less than or equal to 10 phr, less than or equal to 9 phr, less than or equal to 8 phr, or even less than or equal to 7 phr. In one or more embodiments, the amount of the at least one terpene phenol resin may be from 1 phr to 15 phr, from 1 phr to 10 phr, from 1 phr to 9 phr, from 1 to 8 phr, from 1 phr to 7 phr, from 1 phr to 6 phr, from 2 phr to 15 phr, 2 phr to 10 phr, from 2 phr to 9 phr, from 2 phr to 8 phr, from 2 phr to 7 phr, from 2 phr to 6 phr, from 3 phr to 15 phr, 3 phr to 10 phr, from 3 phr to 9 phr, from 3 phr to 8 phr, from 3 phr to 7 phr, from 3 phr to 6 phr, from 4 phr to 15 phr, from 4 phr to 10 phr, from 4 phr to 9 phr, from 4 phr to 8 phr, from 4 phr to 7 phr, from 4 phr to 6 phr, from 5 phr to 15 phr, from 5 phr to 10 phr, from 5 phr to 9 phr, from 5 phr to 8 phr, from 5 phr to 7 phr, or even from 5 phr to 6 phr, or any and all sub-ranges formed from any of these endpoints.

In one or more embodiments, the at least one terpene phenol resin may have a softening point from 100° C. to 160° C. In other embodiments, the at least one terpene phenol resin may have a softening point from 105° C. to 145° C. In one or more embodiments, the at least one terpene phenol resin may have a softening point greater than or equal to 100° C., greater than or equal to 105° C., or even greater than or equal to 115° C. In one or more embodiments, the at least one terpene phenol resin may have a softening point less than or equal to 160° C., less than or equal to 145° C., less than or equal to 130° C., or even less than or equal to 125° C. In one or more embodiments, the at least one terpene phenol resin may have a softening point from 100° C. to 160° C., from 100° C. to 145° C., from 100° C. to 130° C., from 100° C. to 125° C., from 105° C. to 160° C., from 105° C. to 145° C., from 105° C. to 130° C., from 105° C. to 125° C., from 110° C. to 160° C., from 110° C. to 145° C., from 110° C. to 130° C., from 110° C. to 125° C., from 115° C. to 160° C., from 115° C. to 145° C., from 115° C. to 130° C., or even from 115° C. to 125° C., or any and all sub-ranges formed from any of these endpoints.

In one or more embodiments, the at least one terpene phenol resin may have a hydroxyl value from 40 to 200. In other embodiments, the at least one terpene phenol resin may have a hydroxyl value from 40 to 100. In other embodiments, the at least one terpene phenol resin may have a hydroxyl value from 100 to 200. In one or more embodiments, the at least one terpene phenol resin may have a hydroxyl value greater than or equal to 40, greater than or equal to greater than or equal to 60, greater than or equal to 80, greater than or equal to 100, greater than or equal to 120, or even greater than or equal to 140. In one or more embodiments, the at least one terpene phenol resin may have a hydroxyl value less than or equal to 200, less than or equal to 180, less than or equal to 160, less than or equal to 140, less than or equal to 120, less than or equal to 100, or even less than or equal to 80. In one or more embodiments, the at least one terpene phenol resin may have a hydroxyl value from 40 to 200, from 40 to 180, from 40 to 160, from 40 to 140, from 40 to 120, from 40 to 100, from 40 to 80, from 60 to 200, from 60 to 180, from 60 to 160, from 60 to 140, from 60 to 120, from 60 to 100, from 60 to 80, from 80 to 200, from 80 to 180, from 80 to 160, from 80 to 140, from 80 to 120, from 80 to 100, from 100 to 200, from 100 to 180, from 100 to 160, from 100 to 140, from 100 to 120, from 120 to 200, from 120 to 180, from 120 to 160, from 120 to 140, from 140 to 200, from 140 to 180, or even from 140 to 160, or any and all sub-ranges formed from any of these endpoints.

In one or more embodiments, the at least one terpene phenol resin may comprise a first terpene phenol resin having a hydroxyl value from 40 to 100 and a second terpene phenol resin having a hydroxyl value from 100 to 200. In one or more embodiments, the amount of the first terpene phenol resin having a hydroxyl value from 40 to 100 may be less than the amount of the second terpene phenol resin having a hydroxyl value from 100 to 200. For example, the amount of the second terpene phenol resin having a hydroxyl value from 100 to 200 may be present as a majority by weight of the total amount of the terpene phenol resin (e.g., greater than or equal to 51%, greater than or equal to 55%, greater than or equal to 60%, greater than or equal to 70%, greater than or equal to 80%, or even greater than or equal to 90% by weight of the total amount of the terpene phenol resin) and the amount of the first terpene phenol resin having a hydroxyl value from 40 to 100 may be present as a minority by weight of the total amount of the terpene phenol resin (e.g., less than or equal to 49%, less than or equal to 45%, less than or equal to 40%, less than or equal to 30%, less than or equal to 20%, or even less than or equal to 10% by weight of the total amount of terpene phenol resin).

In one or more embodiments, the at least one terpene phenol resin may have a Tg greater than or 50° C., greater than or equal to 55° C., greater than or equal to 60° C., greater than or equal to 65° C., or even greater than or equal to 70° C. In one or more embodiments, the at least one terpene phenol resin may have a Tg less than or equal to 110° C., less than or equal to 100° C., less than or equal to 90° C., or even less than or equal to 80° C. In one or more embodiments, the at least one terpene phenol resin may have a Tg from 50° C. to 110° C., from 50° C. to 100° C., from 50° C. to 90° C., from 50° C. to 80° C., from 55° C. to 110° C., from 55° C. to 100° C., from 55° C. to 90° C., from 55° C. to 80° C., from 60° C. to 110° C., from 60° C. to 100° C., from 60° C. to 90° C., from 60° C. to 80° C., from 65° C. to 110° C., from 65° C. to 100° C., from 65° C. to 90° C., from 65° C. to 80° C., from 70° C. to 110° C., from 70° C. to 100° C., from 70° C. to 90° C., or even from 70° C. to 80° C., or any and all sub-ranges formed from any of these endpoints.

In one or more embodiments, the at least one terpene phenol resin may have a Mw greater than or equal to 500 g/mol, greater than or equal to 550 g/mol, or even greater than or equal to 600 g/mol. In one or more embodiments, the at least one terpene phenol resin may have a Mw less than or equal to 900 g/mol, less than or equal to 850 g/mol, less than or equal to 800 g/mol, or even less than or equal to 750 g/mol. In one or more embodiments, the at least one terpene phenol resin may have a Mw from 500 g/mol to 900 g/mol, from 500 g/mol to 850 g/mol, from 500 g/mol to 800 g/mol, from 500 g/mol to 750 g/mol, from 550 g/mol to 900 g/mol, from 550 g/mol to 850 g/mol, from 550 g/mol to 800 g/mol, from 550 g/mol to 750 g/mol, from 600 g/mol to 900 g/mol, from 600 g/mol to 850 g/mol, from 600 g/mol to 800 g/mol, or even from 600 g/mol to 750 g/mol, or any and all sub-ranges formed from any of these endpoints.

In one or more embodiments, the at least one terpene phenol resin may have a Mn greater than or equal to 400 g/mol, greater than or equal to 450 g/mol, or even greater than or equal to 500 g/mol. In one or more embodiments, the at least one terpene phenol resin may have a Mn less than or equal to 800 g/mol, less than or equal to 750 g/mol, less than or equal to 700 g/mol, or even less than or equal to 650 g/mol. In one or more embodiments, the at least one terpene phenol resin may have a Mn from 400 g/mol to 800 g/mol, from 400 g/mol to 750 g/mol, from 400 g/mol to 700 g/mol, from 400 g/mol to 650 g/mol, from 450 g/mol to 800 g/mol, from 450 g/mol to 750 g/mol, from 450 g/mol to 700 g/mol, from 450 g/mol to 650 g/mol, from 500 g/mol to 800 g/mol, from 500 g/mol to 750 g/mol, from 500 g/mol to 700 g/mol, or even from 500 g/mol to 650 g/mol, or any and all sub-ranges formed from any of these endpoints.

In one or more embodiments, the particular monomers which comprise the terpene phenol resin may vary but may generally include at least one terpene and at least one phenolic compound. Generally, terpenes are compounds derived from isoprene units and have a basic formula of (C₅H₈)ₙ with n being the number of linked isoprene units. In one or more embodiments, the terpene monomer portion of the terpene phenol resin may be selected from the group consisting of alpha-pinene, beta-pinene, D-limonene, dipentene (racemic limonene), careen (also known as delta-3-carene), beta-phellandrene, and combinations thereof. In one or more embodiments, the phenol monomer portion of the terpene phenol resin may be selected from the group consisting of phenol, alkylphenols, bisphenol A, cresol, xylenol, and combinations thereof. In one or more embodiments, the terpene phenol resin may comprise a majority by weight of terpene monomer(s) (e.g., greater than or equal to 51% by weight). In one or more embodiments, the terpene monomer portion of the terpene phenol resin may be from 60% to 95%, from 70% to 95%, or even from 60 to 85% by weight of the overall terpene phenol resin and the phenol monomer portion may be from 5% to 40%, from 5% to 30%, or even from 15% to 40% by weight of the overall terpene phenol resin

Suitable commercial embodiments of the terpene phenol resin are available under the DERTOPHENE brand from Pinova, such as grades H150, T115, and 1510; under the POLYESTER brand from Yashura Chemical, such as grade 5145; and under the SYLVARES and SYLVATRAXX brands from Kraton, such as grades TP2040 and TP300.

Filler Component

As described hereinabove, in one or more embodiments, the filler component of the tire innerliner composition may comprise calcium carbonate. Those skilled in the art may appreciate that calcium carbonate may be a more cost optimized filler than clay. Accordingly, in one or more embodiments, the tire innerliner composition may be substantially free of clays.

In one or more embodiments, the amount of calcium carbonate in the filler component may be from 10 phr to 50 phr. In embodiments, the amount of calcium carbonate in the filler component may be greater than or equal to 10 phr, greater than or equal to 15 phr, or even greater than or equal to 20 phr. In one or more embodiments, the amount of calcium carbonate in the filler component may be less than or equal to 50 phr, less than or equal to 40 phr, less than or equal to 30 phr, or even less than or equal to 25 phr. In one or more embodiments, the amount of calcium carbonate in the filler component may be from 10 phr to 50 phr, from 10 phr to 40 phr, from 10 phr to 30 phr, from 10 phr to 25 phr, from 15 phr to 50 phr, from 15 phr to 40 phr, from 15 phr to 30 phr, from 15 phr to 25 phr, from 20 phr to 50 phr, from 20 phr to 40 phr, from 20 phr to 30 phr, or even from 20 phr to 25 phr, or any and all sub-ranges formed from any of these endpoints.

In one or more embodiments, the filler component may further comprise a reinforcing carbon black filler. In one or more embodiments, the reinforcing carbon black filler may be a recycled reinforcing carbon black filler. In one or more embodiments, the amount of reinforcing carbon black filler in the filler component of the tire innerliner composition may be greater than 30 phr to 75 phr of the carbon black filler. In one or more embodiments, the amount of reinforcing carbon black filler in the filler component may be greater than 30 phr, greater than or equal to 35 phr, greater than or equal to 40 phr, greater than or equal to 45 phr, or even greater than or equal to 50 phr. In one or more embodiments, the amount of reinforcing carbon black filler in the filler component may be less than or equal to 75 phr, less than or equal to 70 phr, less than or equal to 65 phr, or even less than or equal to 60 phr. In one or more embodiments, the amount of reinforcing carbon black filler in the filler component may be from greater than 30 phr to 75 phr, from greater than 30 phr to 70 phr, from greater than 30 phr to 65 phr, from greater than 30 phr to 60 phr, from 35 phr to 75 phr, from 35 phr to 70 phr, from 35 phr to 65 phr, from 35 phr to 60 phr, from 40 phr to 75 phr, from 40 phr to 70 phr, from 40 phr to 65 phr, from 40 phr to 60 phr, from 45 phr to 75 phr, from 45 phr to 70 phr, from 45 phr to 65 phr, from 45 phr to 60 phr, from 50 phr to 75 phr, from 50 phr to 70 phr, from 50 phr to 65 phr, or even from 50 phr to 60 phr, or any and all sub-ranges formed from any of these endpoints.

In one or more embodiments, the reinforcing carbon black filler may have a nitrogen surface area from 20 m²/g to 60 m²/g. In one or more embodiments, the reinforcing carbon black filler may have a nitrogen surface area greater than or equal to 20 m²/g, greater than or equal to 25 m²/g, greater than or equal to 30 m²/g, or even greater than or equal to 35 m²/g. In one or more embodiments, the reinforcing carbon black filler may have a nitrogen surface area less than or equal to 60 m²/g, less than or equal to 55 m²/g, less than or equal to 50 m²/g, or even less than or equal to 45 m²/g. In one or more embodiments, the reinforcing carbon black filler may have a nitrogen surface area from 20 m²/g to 60 m²/g, from 20 m²/g to 55 m²/g, from 20 m²/g to 50 m²/g, from 20 m²/g to 45 m²/g, from 25 m²/g to 60 m²/g, from 25 m²/g to 55 m²/g, from 25 m²/g to 50 m²/g, from 25 m²/g to 45 m²/g, from 30 m²/g to 60 m²/g, from 30 m²/g to 55 m²/g, from 30 m²/g to 50 m²/g, from 30 m²/g to 45 m²/g, from 35 m²/g to 60 m²/g, from 35 m²/g to 55 m²/g, from 35 m²/g to 50 m²/g, or even from 35 m²/g to 45 m²/g, or any and all sub-ranges formed from any of these endpoints.

In one or more embodiments, the carbon black may comprise furnace black, channel blacks, lamp blacks, or combinations thereof. In one or more embodiments, the carbon black may comprise super abrasion furnace (SAF) blacks, high abrasion furnace (HAF) blacks, fast extrusion furnace (FEF) blacks, fine furnace (FF) blacks, intermediate super abrasion furnace (ISAF) blacks, semi-reinforcing furnace (SRF) blacks, medium processing channel blacks, hard processing channel blacks, conducting channel blacks, or combinations thereof. In other embodiments, the carbon black may comprise acetylene blacks. In one or more embodiments, the carbon black may have the designation N-110, N-220, N-339, N-330, N-351, N-550, or N-660, as designated by ASTM D-1765-82a. In embodiments, the carbon black may be in a pelletized form or an unpelletized flocculent mass.

Curative

As described hereinabove, in one or more embodiments, the tire innerliner compositions may comprise at least one curative. In one or more embodiments, the at least one curative may comprise a vulcanizing agent, a vulcanizing accelerator, a vulcanizing activator, a vulcanizing inhibitor, an anti-scorching agent, or combinations thereof. Vulcanizing accelerators and vulcanizing activators act as catalysts for the vulcanization agent. Various vulcanizing inhibitors and anti-scorching agents are known in the art and can be selected by one skilled in the art based on the vulcanizate properties desired.

Examples of suitable types of vulcanizing agents include but are not limited to, sulfur or peroxide-based curing components. In one or more embodiments, the vulcanizing agent may comprise a sulfur-based curative, a peroxide-based curative, or combinations thereof. In one or more embodiments, the sulfur-based vulcanizing agents may comprise “rubbermaker's” soluble sulfur; sulfur donating curing agents, such as an amine disulfide, polymeric polysulfide, or sulfur olefin adducts; insoluble polymeric sulfur; or combinations thereof. For a general disclosure of suitable vulcanizing agents and other components used in curing (e.g., vulcanizing inhibitor and anti-scorching agents), one may refer to Kirk-Othmer, Encyclopedia of Chemical Technology, 3rd ed., Wiley Interscience, N.Y. 1982, Vol. 20, pp. 365 to 468, particularly Vulcanization Agents and Auxiliary Materials, pp. 390 to 402, or Vulcanization by A. Y. Coran, Encyclopedia of Polymer Science and Engineering, Second Edition (1989 John Wiley & Sons, Inc.), both of which are incorporated herein by reference. In one or more embodiments, the amount of vulcanizing agent in the at least one curative may be greater than or equal to 0.1 phr, greater than or equal to 0.5 phr, or even greater than or equal to 1 phr. In one or more embodiments, the amount of vulcanizing agent in the at least one curative may be less than or equal to 10 phr, less than or equal to 7 phr, less than or equal to 5 phr, or even less than or equal to 3 phr. In one or more embodiments, the amount of vulcanizing agent in the at least one curative may be from 0.1 phr to 10 phr, from 0.1 phr to 7 phr, from 0.1 phr to 5 phr, from 0.1 phr to 3 phr, from 0.5 phr to 10 phr, from 0.5 phr to 7 phr, from 0.5 phr to 5 phr, from 0.5 phr to 3 phr, from 1 phr to 10 phr, from 1 phr to 7 phr, from 1 phr to 5 phr, or even from 1 phr to 3 phr, or any and all sub-ranges formed from any of these endpoints.

Vulcanizing accelerators may be used to control the time and/or temperature required for vulcanization and to improve properties of the vulcanizate. Examples of suitable vulcanizing accelerators include, but are not limited to, thiazole vulcanization accelerators, such as 2-mercaptobenzothiazole, 2,2′-dithiobis(benzothiazole) (MBTS), N-cyclohexyl-2-benzothiazole-sulfenamide (CBS), N-tert-butyl-2-benzothiazole-sulfenamide (TBBS), and the like; guanidine vulcanization accelerators, such as diphenyl guanidine (DPG) and the like; thiuram vulcanizing accelerators; carbamate vulcanizing accelerators; and the like. In one or more embodiments, the amount of vulcanizing accelerator in the at least one curative may be greater than or equal to 0.1 phr, greater than or equal to 0.5 phr, or even greater than or equal to 1 phr. In one or more embodiments, the amount of vulcanizing accelerator in the at least one curative may be less than or equal to 10 phr, less than or equal to 7 phr, less than or equal to 5 phr, or even less than or equal to 3 phr. In one or more embodiments, the amount of vulcanizing accelerator in the at least one curative may be from 0.1 phr to 10 phr, from 0.1 phr to 7 phr, from 0.1 phr to 5 phr, from 0.1 phr to 3 phr, from 0.5 phr to 10 phr, from 0.5 phr to 7 phr, from 0.5 phr to 5 phr, from 0.5 phr to 3 phr, from 1 phr to 10 phr, from 1 phr to 7 phr, from 1 phr to 5 phr, or even from 1 phr to 3 phr, or any and all sub-ranges formed from any of these endpoints. In one or more embodiments, any vulcanization accelerator used may exclude any thiurams such as thiuram monosulfides and thiuram polysulfides (examples of which include TMTM (tetramethyl thiuram monosulfide), TMTD (tetramethyl thiuram disulfide), DPTT (dipentamethylene thiuram tetrasulfide), TETD (tetraethyl thiuram disulfide), TiBTD (tetraisobutyl thiuram disulfide), and TBzTD (tetrabenzyl thiuram disulfide)).

Vulcanizing activators are additives used to support vulcanization. In one or more embodiments, the vulcanizing activators may include an inorganic, an organic component, or combinations thereof. In one or more embodiments, the inorganic vulcanizing activator may comprise zinc oxide. In embodiments, the amount of zinc oxide may be limited (e.g., less than or equal to 3 phr) and replaced by the terpene phenol resin while still achieving sufficient cure characteristics. In one or more embodiments, the amount of zinc oxide in the at least one curative may be greater than or equal to 0 phr, greater than or equal to 0.5 phr, or even greater than or equal to 1 phr. In one or more embodiments, the amount of zinc oxide in the at least one curative may be less than or equal to 3 phr, less than or equal to 2.5 phr, or even less than or equal to 1 phr. In one or more embodiments, the amount of zinc oxide in the at least one curative may be from 0 phr to 3 phr, from 0 phr to 2.5 phr, from 0 phr to 2 phr, from 0.5 phr to 3 phr, from 0.5 phr to 2.5 phr, from 0.5 phr to 2 phr, from 1 phr to 3 phr, from 1 phr to 2.5 phr, or even from 1 phr to 2 phr, or any and all sub-ranges formed from any of these endpoints.

In other embodiments, the organic vulcanizing activator may include stearic acid, palmitic acid, lauric acid, zinc salts of each of the foregoing, or combinations thereof.

In one or more embodiments, the amount of vulcanizing activator in the at least one curative may be greater than or equal to 0.1 phr, greater than or equal to 0.5 phr, or even greater than or equal to 1 phr. In one or more embodiments, the amount of vulcanizing activator in the at least one curative may be less than or equal to 6 phr, less than or equal to 5 phr, less than or equal to 4 phr, or even less than or equal to 3 phr. In one or more embodiments, the amount of vulcanizing activator in the at least one curative may be from 0.1 phr to 6 phr, from 0.1 phr to 5 phr, from 0.1 phr to 4 phr, from 0.1 phr to 3 phr, from 0.5 phr to 6 phr, from 0.5 phr to 5 phr, from 0.5 phr to 4 phr, from 0.5 phr to 3 phr, from 1 phr to 6 phr, from 1 phr to 5 phr, from 1 phr to 4 phr, or even from 1 phr to 3 phr, or any and all sub-ranges formed from any of these endpoints.

In one or more embodiments, both zinc oxide and stearic acid may be used as vulcanizing activators with the total amount utilized falling within one of the foregoing ranges. In one or more embodiments, the only vulcanizing activators used may be zinc oxide and stearic acid.

In one or more embodiments, the vulcanizing activator may comprise one or more thiourea compounds. Generally, a thiourea compound may be understood as a compound having the structure (R¹) (R²)NS(═C)N(R³)(R⁴) wherein each of R¹, R², R³, and R⁴ are independently selected from H, alkyl, aryl, and N-containing substituents (e.g., guanyl). Optionally, two of the foregoing structures may be bonded together through N (removing one of the R groups) in a dithiobiurea compound. In one or more embodiments, one of R¹ or R² and one of R³ or R⁴ may be bonded together with one or more methylene groups (—CH₂—) there between. In one or more embodiments, the thiourea has one or two of R¹, R², R³ and R⁴ selected from one of the foregoing groups with the remaining R groups being hydrogen. Exemplary alkyl include C1-C6 linear, branched or cyclic groups such as methyl, ethyl, propyl, iso-propyl, butyl, iso-butyl, pentyl, hexyl, and cyclohexyl. Exemplary aryl include C6-C12 aromatic groups such as phenyl, tolyl, and naphthyl. Exemplary thiourea compounds include, but are not limited to, dihydrocarbylthioureas such as dialkylthioureas and diarylthioureas. Non-limiting examples of particular thiourea compounds include one or more of thiourea, N,N′-diphenylthiourea, trimethylthiourea, N,N′-diethylthiourea (DEU), N,N′-dimethylthiourea, N,N′-dibutylthiourea, ethylenethiourea, N,N′-diisopropylthiourea, N,N′-dicyclohexylthiourea, 1,3-di(o-tolyl)thiourea, 1,3-di(p-tolyl)thiourea, 1,1-diphenyl-2-thiourea, 2,5-dithiobiurea, guanylthiourea, 1-(1-naphthyl)-2-thiourea, 1-phenyl-2-thiourea, p-tolylthiourea, and o-tolylthiourea. In one or more embodiments, the vulcanizing activator may include at least one thiourea compound selected from thiourea, N,N′-di ethylthiourea, trimethylthiourea, N,N′-diphenylthiourea, and N—N′-dim ethylthiourea.

Vulcanization inhibitors are used to control the vulcanization process and generally retard or inhibit vulcanization until the desired time and/or temperature is reached. In one or more embodiments, the vulcanization inhibitor may comprise magnesium oxide, cyclohexylthiophthalmide, or combinations thereof. In one or more embodiments, the amount of vulcanization inhibitor in the at least one curative may be greater than or equal to 0.1 phr, greater than or equal to 0.5 phr, or even greater than or equal to 1 phr. In one or more embodiments, the amount of vulcanization inhibitor in the at least one curative may be less than or equal to 3 phr or even less than or equal to 2 phr. In one or more embodiments, the amount of vulcanization inhibitor in the at least one curative may be from 0.1 phr to 3 phr, from 0.1 phr to 2 phr, from 0.5 phr to 3 phr, from 0.5 phr to 2 phr, from 1 phr to 3 phr, or even from 1 phr to 2 phr, or any and all sub-ranges formed from any of these endpoints.

Non-Terpene Phenol Resin

In one or more embodiments, the tire innerliner composition described herein may further comprise greater than 0 phr to 10 phr of a non-terpene phenol resin. In one or more embodiments, the amount of non-terpene phenol resin may be limited (e.g., less than or equal to 10 phr) and replaced with terpene phenol resin such that the desired amount of gas permeability is achieved. In one or more embodiments, the amount of non-terpene phenol resin may be greater than 0 phr, greater than or equal to 0.5 phr, greater than or equal to 1 phr, or even greater than or equal to 2 phr. In one or more embodiments, the amount of non-terpene phenol resin may be less than or equal to 10 phr, less than or equal to 7 phr, less than or equal to 5 phr, or even less than or equal to 3 phr. In one or more embodiments, the amount of non-terpene phenol resin may be from greater than 0 phr to 10 phr, from greater than 0 phr to 7 phr, from greater than 0 phr to 5 phr, from greater than 0 phr to 3 phr, from 0.5 phr to 10 phr, from 0.5 phr to 7 phr, from 0.5 phr to 5 phr, from 0.5 phr to 3 phr, from 1 phr to 10 phr, from 1 phr to 7 phr, from 1 phr to 5 phr, from 1 phr to 3 phr, from 2 phr to 10 phr, from 2 phr to 7 phr, from 2 phr to 5 phr, or even from 2 phr to 3 phr, or any and all sub-ranges formed from any of these endpoints.

In one or more embodiments, the non-terpene phenol resin may comprise a hydrocarbon resin, a phenolic resin, or combinations thereof. In one or more embodiments, the hydrocarbon resin may comprise dicyclopentadiene resin. In other embodiments, the phenolic resin may comprise alkylphenol-formaldehyde resin.

Liquid Plasticizer

In one or more embodiments, the tire innerliner composition may further comprise greater than 0 phr to 10 phr of a liquid plasticizer. In one or more embodiments, the amount of liquid plasticizer may be limited (e.g., less than or equal to 10 phr) and replaced by the terpene phenol resin while still achieving sufficient cure characteristics.

In one or more embodiments, the amount of liquid plasticizer in the tire innerliner composition is greater than 0 phr, greater than or equal to 0.5 phr, greater than or equal to 1 phr, or even greater than or equal to 2 phr. In one or more embodiments, the amount of liquid plasticizer in the tire innerliner composition may be less than or equal to 10 phr, less than or equal to 8 phr, less than or equal to 6 phr, or even less than or equal to 4 phr. In one or more embodiments, the amount of liquid plasticizer in the tire innerliner composition may be from greater than 0 phr to 10 phr, from greater than 0 phr to 8 phr, from greater than 0 phr to 6 phr, from greater than 0 phr to 4 phr, from 0.5 phr to 10 phr, from 0.5 phr to 8 phr, from 0.5 phr to 6 phr, from 0.5 phr to 4 phr, from 1 phr to 10 phr, from 1 phr to 8 phr, from 1 phr to 6 phr, from 1 phr to 4 phr, from 2 phr to 10 phr, from 2 phr to 8 phr, from 2 phr to 6 phr, or even from 2 phr to 4 phr, or any and all sub-ranges formed from any of these endpoints.

In one or more embodiments, the liquid plasticizer may comprise an oil, an ester plasticizer, or combinations thereof.

In one or more embodiments, the liquid plasticizer may comprise an oil. In one or more embodiments, the oil may comprise a free oil (which is usually added during the compounding process), an extender oil (which is used to extend a rubber), or combinations thereof. In one or more embodiments, the free oil or extender oil may comprise aromatic, naphthenic, and low polycyclic aromatic (“PCA”) oils (petroleum-sourced or plant-sources). In one or more embodiments, the low PCA oils may have a polycyclic aromatic content of less than 3 percent by weight as determined by the IP346 method.

In one or more embodiments, the oil may comprise petroleum-based oils (e.g., aromatic, naphthenic, and low PCA oils), plant oils (e.g., vegetable oil, nut oil, and seed oil, or combinations thereof. In one or more embodiments, the plant oils may comprise synthetic triglycerides, natural triglycerides (i.e., sourced from a plant), or combinations thereof. In other embodiments, the petroleum-sourced low PCA oils may comprise mild extraction solvates (MES), treated distillate aromatic extracts (TDAE), TRAE, heavy naphthenics, or combinations thereof. Exemplary IVIES oils are available commercially as CATENEX SNR from SHELL, PROREX 15, and FLEXON 683 from EXXONMOBIL, VIVATEC 200 from BP, PLAXOLENE MS from TOTAL FINA ELF, TUDALEN 4160/4225 from DAHLEKE, MES-H from REPSOL, MES from Z8, and OLIO MES S201 from AGIP. Exemplary TDAE oils are available as TYREX 20 from EXXONMOBIL, VIVATEC 500, VIVATEC 180, and ENERTHENE 1849 from BP, and EXTENSOIL 1996 from REPSOL. Exemplary heavy naphthenic oils are available as SHELLFLEX 794, ERGON BLACK OIL, ERGON H2000, CROSS C2000, CROSS C2400, and SAN JOAQUIN 2000L. In other embodiments, the low PCA oil may comprise various plant-sourced oils such as can be harvested from vegetables, nuts, and seeds. Non-limiting examples include, but are not limited to, soy or soybean oil, sunflower oil (including high oleic sunflower oil), safflower oil, corn oil, linseed oil, cotton seed oil, rapeseed oil, cashew oil, sesame oil, camellia oil, jojoba oil, hemp oil, macadamia nut oil, coconut oil, and palm oil.

In one or more embodiments, the oil may have a Tg greater than or equal to −100° C., greater than or equal to −90° C., or even greater than or equal to −80° C. In one or more embodiments, the oil may have a Tg less than or equal to −40° C., less than or equal to −50° C., less than or equal to −60° C., or even less than or equal to −70. In one or more embodiments, the oil may have a Tg from −100° C. to −40° C., from −100° C. to −50° C., from −100° C. to −60° C., from −100° C. to −70° C., from −90° C. to −40° C., from −90° C. to −50° C., from −90° C. to −60° C., from −90° C. to −70° C., from −90° C. to −80° C., from −90° C. to −80° C., from −90° C. to −80° C., or even from −90° C. to −80° C., or any and all sub-ranges formed from many of these endpoints.

In other embodiments, the liquid plasticizer may comprise an ester plasticizer. In one or more embodiments, the ester plasticizer may comprise phosphate esters, phthalate esters, adipate esters, oleate esters (i.e., derived from oleic acid), or combinations thereof. In one or more embodiments, taking into account that an ester is a chemical compound derived from an acid wherein at least one —OH is replaced with an —O-alkyl group, various alkyl groups may be used in suitable ester plasticizers for use in the tire innerliner composition, including generally linear or branched alkyl of C₁ to C₂₀ (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀), or C₆ to C₁₂. Certain of the foregoing esters are based upon acids which have more than one —OH group and, thus, may accommodate one or more than one O-alkyl group (e.g., trialkyl phosphates, dialkyl phthalates, dialkyl adipates). Non-limiting examples of suitable ester plasticizers include trioctyl phosphate, dioctyl phthalate, dioctyl adipate, nonyl oleate, octyl oleate, and combinations thereof.

In one or more embodiments, the ester plasticizer may have a Tg greater than or equal to −70° C., greater than or equal to −65° C., or even greater than or equal to −60° C. In one or more embodiments, the ester plasticizer may have a Tg less than or equal to −40° C., less than or equal to −45° C., or even less than or equal to −50° C. In one or more embodiments, the ester plasticizer may have a Tg from −70° C. to −40° C., from −70° C. to −45° C., from −70° C. to −50° C., from −65° C. to −40° C., from −65° C. to −45° C., from −65° C. to −50° C., from −60° C. to −40° C., from −60° C. to −45° C., or even from −60° C. to −50° C., or any and all sub-ranges formed from any of these endpoints.

Additives

Various other additives that may optionally be added to the tire innerliner compositions disclosed herein include waxes (which in some instances are antioxidants), processing aids, reinforcing resins, peptizers, and antioxidants/antidegradant. Ingredients which are antidegradants may also be classified as an antiozonant or antioxidant, such as those selected from: N,N′ disubstituted-p-phenylenediamines, such as N-1,3-dimethylbutyl-N′ phenyl-p-phenylenediamine (6PPD), N,N′-Bis(1,4-dimethylpently)-p-phenylenediamine (77PD), N-phenyl-N-isopropyl-p-phenylenediamine (IPPD), and N-phenyl-N′-(1,3-dimethylbutyl)-p-phenylenediamine (HPPD). Other examples of antidegradants include, acetone diphenylamine condensation product, 2,4-Trimethyl-1,2-dihydroquinoline, Octylated Diphenylamine, 2,6-di-t-butyl-4-methyl phenol, and certain waxes. In other embodiments, the composition may be free or essentially free of antidegradants such as antioxidants or antiozonants.

Preparing the Tire Innerliner Composition

The particular steps involved in preparing the tire innerliner compositions disclosed herein may be those of conventionally practiced methods comprising mixing the ingredients in at least one non-productive master-batch stage and a final productive mixing stage. In one or more embodiments, the tire innerliner composition may be prepared by combining the ingredients for the tire innerliner composition (as disclosed above) by methods known in the art, such as, for example, by kneading the ingredients together in a Banbury mixer or on a milled roll. Such methods may include at least one non-productive master-batch mixing stage and a final productive mixing stage. The term non-productive master-batch stage is known to those of skill in the art and generally understood to be a mixing stage (or stages) where no vulcanizing agents or vulcanization accelerators are added. The term final productive mixing stage is also known to those of skill in the art and generally understood to be the mixing stage where the vulcanizing agents and vulcanization accelerators are added into the tire innerliner composition. In one or more embodiments, the rubber composition may be prepared by a process comprising more than one non-productive master-batch mixing stage.

In other embodiments, the tire innerliner composition may be prepared by a process wherein the master-batch mixing stage includes at least one of tandem mixing or intermeshing mixing. Tandem mixing may be understood as including the use of a mixer with two mixing chambers with each chamber having a set of mixing rotors; generally, the two mixing chambers are stacked together with the upper mixer being the primary mixer and the lower mixer accepting a batch from the upper or primary mixer. In one or more embodiments, the primary mixer utilizes intermeshing rotors and in other embodiments the primary mixer utilizes tangential rotors. In one or more embodiments, the lower mixer utilizes intermeshing rotors. Intermeshing mixing may be understood as including the use of a mixer with intermeshing rotors. Intermeshing rotors refers to a set of rotors where the major diameter of one rotor in a set interacts with the minor diameter of the opposing rotor in the set such that the rotors intermesh with each other. Intermeshing rotors must be driven at an even speed because of the interaction between the rotors. In contrast to intermeshing rotors, tangential rotors refers to a set of rotors where each rotor turns independently of the other in a cavity that may be referred to as a side. Generally, a mixer with tangential rotors may include a ram whereas a ram is not necessary in a mixer with intermeshing rotors.

In one or more embodiments, the elastomer component and filler components may be added in a non-productive or master-batch mixing stage or stages. In one or more embodiments, the vulcanizing agent and the vulcanizing accelerator component of the at least one curative may be added in a final or productive mixing stage.

In one or more embodiments, the tire innerliner composition may be prepared using a process wherein at least one non-productive master batch mixing stage is conducted at a temperature of about 130° C. to about 200° C. In one or more embodiments, the tire innerliner composition may be prepared using a final productive mixing stage conducted at a temperature below the vulcanization temperature in order to avoid unwanted pre-cure of the rubber composition. Therefore, in one or more embodiments, the temperature of the productive or final mixing stage may not exceed about 120° C. and may be from about 40° C. to about 120° C., from about 60° C. to about 110° C., or even from about 75° C. to about 100° C. In one or more embodiments, the tire innerliner composition may be prepared according to a process that includes at least one non-productive mixing stage and at least one productive mixing stage.

Properties of the Tire Innerliner Composition

The tire innerliner compositions described herein include, inter alia, terpene phenol resin, which provides the desired gas permeability while maintaining sufficient durability and cure characteristics. In one or more embodiments, the amount of liquid plasticizer and/or zinc oxide may be reduced and replaced with terpene phenol resin while maintaining sufficient blow point and scorch.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A tire innerliner composition comprising:
an elastomer component comprising halogenated butyl rubber;
at least one terpene phenol resin having a softening point from 100° C. to 160° C. and a hydroxyl value from 40 to 200;
filler component comprising calcium carbonate; and
at least one curative.

2. The tire innerliner composition of claim 1, wherein the tire innerliner composition comprises 75 phr to 100 phr of the halogenated butyl rubber.

3. The tire innerliner composition of claim 1, wherein the halogenated butyl rubber comprises halogenated bromobutyl rubber.

4. The tire innerliner composition of claim 3, wherein the halogenated bromobutyl rubber is a brominated copolymer of isobutylene and isoprene (BIIR).

5. The tire innerliner composition of claim 1, wherein the elastomer component further comprises styrene-butadiene copolymer rubber, polybutadiene rubber, natural rubber, polyisoprene rubber, or combinations thereof.

6. The tire innerliner composition of claim 5, wherein the elastomer component comprises 1 phr to 25 phr of the natural rubber.

7. The tire innerliner composition of claim 1, wherein the tire innerliner composition comprises 1 phr to 15 phr of the at least one terpene phenol resin.

8. The tire innerliner composition of claim 1, wherein the at least one terpene phenol resin has a softening point from 105° C. to 145° C.

9. The tire innerliner composition of claim 1, wherein the at least one terpene phenol resin has a hydroxyl value from 40 to 100.

10. The tire innerliner composition of claim 1, wherein the at least one terpene phenol resin has a hydroxyl value from 60 to 200.

11. The tire innerliner composition of claim 1, wherein the tire innerliner composition further comprises greater than 0 phr to 10 phr of a non-terpene phenol resin.

12. The tire innerliner composition of claim 11, wherein the non-terpene phenol resin comprises a hydrocarbon resin, a phenolic resin, or combinations thereof.

13. The tire innerliner composition of claim 12, wherein the hydrocarbon resin comprises dicyclopentadiene resin.

14. The tire innerliner composition of claim 12, wherein the phenolic resin comprises alkylphenol-formaldehyde resin.

15. The tire innerliner composition of claim 1, wherein the filler component comprises 10 phr to 50 phr of the calcium carbonate.

16. The tire innerliner composition of claim 1, wherein the tire innerliner composition further comprises greater than 0 phr to 10 phr of a liquid plasticizer.

17. The tire innerliner composition of claim 1, wherein the filler component further comprises greater than 30 phr to 75 phr of a reinforcing carbon black filler.

18. The tire innerliner composition of claim 17, wherein the reinforcing carbon black filler has a nitrogen surface area from 20 m²/g to 60 m²/g.

19. The tire innerliner composition of claim 1, wherein the at least one curative comprises greater than 0 and less than or equal to 3 phr of zinc oxide.

20. The tire innerliner composition of claim 1, wherein the tire innerliner composition is substantially free of clays.

21. (canceled)
